(19) United States
(12) Patent Application Publication
(10) Pub. No.: US 2019/0163908 A1
(43) Pub. Date: May 30, 2019

(54) CONTROL METHOD AND UNIT OF MOBILE STORAGE DEVICES, AND STORAGE MEDIUM

(71) Applicant: Siemens Aktiengesellschaft, Munich (DE)

(72) Inventors: Wen TANG, Beijing (CN); Stefan BAGDOHN, Muenchen (DE)

(73) Assignee: Siemens Aktiengesellschaft, Munich (DE)

(21) Appl. No.: 16/045,881

(22) Filed: Jul. 26, 2018

(30) Foreign Application Priority Data
Nov. 30, 2017 (CN) 2017 1 1243953.0

(51) Int. Cl. G06F 21/56

(52) U.S. Cl. CPC G06F 21/568; G06F 21/562

(57) ABSTRACT

A control method, unit and system are designed to reduce security risks caused by the using mobile storage devices. In an embodiment, the unit includes: a mobile storage device interface; a memory to store a device management program; and a processor, configured to call the device management program after detecting that the mobile storage device interface is connected with a mobile storage device. The processor is configured to execute the device management program to damage a file system on the connected mobile storage device, generate a first mirror image file (including an object file) of the file system of the mobile storage device in response to a file copy instruction, and recover the file system of the mobile storage device using the first mirror image file. The device management unit thereby can avoid virus transmission caused by pull-out of the mobile storage device in a virus killing process.

### PRIORITY STATEMENT

The present application hereby claims priority under 35 U.S.C. § 119 to Chinese patent application number CN 201711243953.0 filed Nov. 30, 2017, the entire contents of which are hereby incorporated herein by reference.

### FIELD

At least one embodiment of the present application generally relates to the technical field of information security, particularly to a control method, unit and system of mobile storage devices.

### BACKGROUND

Mobile storage devices, such as Universal Serial Bus (USB), greatly facilitate file storage, but also bring in virus transmission, network attack and other security risks at the same time.

At present, antivirus software is generally used for scanning the mobile storage devices to achieve the goal of virus checking and killing. The application of the antivirus software requires to know the characteristics of the viruses in advance, and cannot effectively cope with new viruses.

How to control the mobile storage devices to effectively prevent the security risks is an urgent problem at present.

### SUMMARY

Embodiments of the present invention provides a control method, unit and system of mobile storage devices to effectively prevent security risks caused by the use of the mobile storage device.

For the first embodiment, the present invention provides a device management method. The method comprises: after a device management unit detects that a mobile storage device is connected to a mobile storage device interface provided by the device management unit, executing the following device management steps: damaging a file system on the mobile storage device; receiving a file copy instruction, wherein the file copy instruction is used for indicating to copy an object file to the mobile storage device; in response to the file copy instruction, generating a first mirror image file of the file system of the mobile storage device, wherein the first mirror image file comprises the object file; and recovering the file system of the mobile storage device by using the first mirror image file.

For the second embodiment, the present invention provides a device management unit, comprising: an interface detection module, configured to be used for detecting whether a mobile storage device interface is connected with a mobile storage device or not; a device processing module, configured to be used for, after the detection module detects that the mobile storage device interface is connected with a mobile storage device, executing the following device management steps: damaging a file system on the mobile storage device; receiving a file copy instruction, wherein the file copy instruction is used for indicating to copy an object file to the mobile storage device; in response to the file copy instruction, generating a first mirror image file of the file system of the mobile storage device, wherein the first mirror image file comprises the object file; and recovering the file system of the mobile storage device by using the first mirror image file.

For the third embodiment, the present invention provides a device management unit, comprising: a mobile storage device interface, configured to be used for connecting a mobile storage device; a memory, configured to be used for storing a device management program; and a processor, configured to be used for calling the device management program, detecting whether the mobile storage device interface is connected with a mobile storage device, and after detecting that the mobile storage device interface is connected with a mobile storage device, executing the following device management steps: damaging a file system on the connected mobile storage device; receiving a file copy instruction, wherein the file copy instruction is used for indicating to copy an object file to the connected mobile storage device; in response to the file copy instruction, generating a first mirror image file of the file system of the mobile storage device, wherein the first mirror image file comprises the object file; and recovering the file system of the connected mobile storage device by using the first mirror image file.

For the fourth embodiment, the present invention provides a storage medium, comprising a device management program, wherein when the device management program is called by a processor, executing the method provided by the first embodiment or any possible implementation way of the first embodiment.

### BRIEF DESCRIPTION OF THE DRAWINGS

FIG. 1 and FIG. 2 are structure diagrams of a device management unit provided by the embodiment of the present invention.

FIG. 3 is a flow chart of a mobile storage device control method provided by the embodiment of the present invention.

FIG. 4 is another schematic diagram of a device management unit provided by the embodiment of the present invention.

Drawing Marker List:

| | | |
|---|---|---|
| 10: Device management | 20: Mobile storage | 30: Device |
| unit | device | management unit |
| 40: File copy instruction | 50: Object file | 60: File server |
| 70: User | 31: First mirror image | 32: Second |
| | file | mirror image file |
| 101: Mobile storage | 102: Interface control | 103: Processor |
| device interface | card | |
| 104: Display screen | 105: Network interface | 106: Memory |
| 1061: Operating system | 1062: Device | 1063: Antivirus |
| | management program | program |

S301: Detecting that a mobile storage device 20 is inserted into a mobile
storage device interface 101
S302: Judging whether the mobile storage device 20 is bound with the
mobile storage device interface 101 or not
S303: Displaying the interface state as ′Connection Abnormal′, and
prohibiting file copying
S304: displaying the interface state as ′Device Connected Normally′

| | |
|---|---|
| S305: Device preprocessing | S306: Damaging a file system of the |
| | mobile storage device 20 |
| S307: Receiving a file copy | S308: Generating a first mirror image |
| instruction 40 | file 31 |

S309: Recovering the file system of the mobile storage device 20 by using
the first mirror image file 31
S310: After the mobile storage device 20 is pulled out, displaying the
interface state as ′device reuse′
S311: Judging whether the mobile storage device 20 is inserted back
within the preset time or not after being pulled out
S312: Giving out an alarm

| | |
|---|---|
| 301: Interface detection | 302: Device processing module |
| module | |

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

For the first embodiment, the present invention provides a device management method. The method comprises: after a device management unit detects that a mobile storage device is connected to a mobile storage device interface provided by the device management unit, executing the following device management steps: damaging a file system on the mobile storage device; receiving a file copy instruction, wherein the file copy instruction is used for indicating to copy an object file to the mobile storage device; in response to the file copy instruction, generating a first mirror image file of the file system of the mobile storage device, wherein the first mirror image file comprises the object file; and recovering the file system of the mobile storage device by using the first mirror image file.

If the file is directly copied to a USB flash disk and then performing virus killing, the goal of virus checking and killing can also be achieved, but the following operations cannot be avoided: after the file copying is finished, in a virus killing process, if the mobile storage device is pulled out of the mobile storage device interface, the mobile storage device can be used normally and perform file copying, and if the file carries a virus, virus transmission can be possibly caused. In the method, the device management unit recovers the file system of the mobile storage device by using the mirror image file, thereby avoiding the virus transmission caused by the pull-out of the mobile storage device in the virus killing process.

The method optionally comprises: before damaging the file system on the mobile storage device, acquiring a first parameter, wherein the first parameter is the parameter required by recovering the file system of the mobile storage device; and when generating the first mirror image file, generating the first mirror image file according to the first parameter and the object file. Or, optionally, before damaging the file system on the mobile storage device, generating a second mirror image file of the file system of the mobile storage device, wherein the second mirror image file corresponds to the situation that the storage content in the mobile storage device is null; and when generating the first mirror image file, writing the object file into the second mirror image file to generate the first mirror image file.

A method for recovering and acquiring the file system of the mobile storage device is provided above.

Optionally, before generating the first mirror image file, inspecting whether the object file contains a virus or not, and if the object file does not contain viruses, generating the first mirror image file; or before recovering the file system of the mobile storage device by using the first mirror image file, inspecting whether the first mirror image file contains a virus or not; if the first mirror image file does not contain viruses, recovering the file system of the mobile storage device by using the first mirror image file.

In this way, the method can effectively prevent viruses carried by the object file from infecting downstream devices.

Optionally, before damaging the file system on the mobile storage device, formatting the file system of the mobile storage device.

In this way, the transmission of viruses carried by the mobile storage device itself can be avoided.

Optionally, after detecting that the mobile storage device is connected to the mobile storage device interface, before executing the device management steps, judging whether the mobile storage device is allowed to perform file copying through the mobile storage device interface or not; if the mobile storage device is allowed to perform file copying through the mobile storage device interface, executing the device management steps; and if the mobile storage device prohibited to perform file copying through the mobile storage device interface, giving out an alarm.

In this way, binding of the mobile storage device and the mobile storage device interface is implemented, and an unauthorized mobile storage device is prohibited to perform file copying through the interface, thereby further preventing hostile attacks, and effectively avoiding transmission of incidentally infected viruses.

Optionally, if the mobile storage device is allowed to perform file copying through the mobile storage device interface, giving out a first prompting message, wherein the first prompting message is used for indicating that the mobile storage device is allowed to perform file copying through the mobile storage device interface.

Optionally, after recovering the file system of the mobile storage device by using the first mirror image file, giving out a second prompting message, wherein the second prompting message is used for indicating the finish of the file copying of the mobile storage device.

Optionally, if the process of recovering the file system of the mobile storage device by using the first mirror image file is interrupted, giving out a third prompting message, wherein the third prompting message is used for indicating the interruption of the file copying of the mobile storage device.

In this way, information prompting is intuitively provided to a user of the mobile storage device through the prompting messages.

For the second embodiment, the present invention provides a device management unit, comprising: an interface detection module, configured to be used for detecting whether a mobile storage device interface is connected with a mobile storage device or not; a device processing module, configured to be used for, after the detection module detects that the mobile storage device interface is connected with a mobile storage device, executing the following device management steps: damaging a file system on the mobile storage device; receiving a file copy instruction, wherein the file copy instruction is used for indicating to copy an object file to the mobile storage device; in response to the file copy instruction, generating a first mirror image file of the file system of the mobile storage device, wherein the first mirror image file comprises the object file; and recovering the file system of the mobile storage device by using the first mirror image file.

If the file is directly copied to a USB flash disk and then performing virus killing, the goal of virus checking and killing can also be achieved, but the following operations can not be avoided: after the file copying is finished, in a virus killing process, if the mobile storage device is pulled out of the mobile storage device interface, the mobile storage device can be used normally and perform file copying, and if the file carries a virus, virus transmission can be possibly caused. The device management unit recovers the file system of the mobile storage device by using the mirror image file, thereby avoiding the virus transmission caused by the pull-out of the mobile storage device in the virus killing process.

Optionally, the device processing module is also configured to be used for, before damaging the file system on the mobile storage device, acquiring a first parameter, wherein the first parameter is the parameter required by recovering the file system of the mobile storage device; the device processing module, when generating the first mirror image file, is specifically configured to be suitable for generating the first mirror image file according to the first parameter and the object file.

Or, the device processing module is also configured to be used for, before damaging the file system on the mobile storage device, generating a second mirror image file of the file system of the mobile storage device, wherein the second mirror image file corresponds to the situation that the storage content in the mobile storage device is null; the device processing module, when generating the first mirror image file, is specifically configured to be suitable for writing the object file into the second mirror image file to generate the first mirror image file.

An optional scheme for recovering and acquiring the file system of the mobile storage device is provided above.

Optionally, the device processing module is also configured to be used for, before generating the first mirror image file, inspecting whether the object file contains a virus or not; the device processing module, when generating the first mirror image file, is specifically configured to be suitable for, if the object file does not contain viruses, generating the first mirror image file; or

the device processing module is also configured to be used for, before recovering the file system of the mobile storage device by using the first mirror image file, inspecting whether the first mirror image file contains a virus or not; the device processing module, when recovering the file system of the mobile storage device by using the first mirror image file, is specifically configured to be suitable for, if the first mirror image file does not contain viruses, recovering the file system of the mobile storage device by using the first mirror image file.

In this way, the method can effectively prevent viruses carried by the object file from infecting downstream devices.

Optionally, the device processing module is also used for, before damaging the file system on the mobile storage device, formatting the file system of the mobile storage device.

In this way, the transmission of viruses carried by the mobile storage device itself can be avoided.

Optionally, the device processing module is also configured to be used for, optionally, after detecting that the mobile storage device interface is connected with a mobile storage device, before executing the device management steps, judging whether the mobile storage device is allowed to perform file copying through the mobile storage device interface or not; if the mobile storage device is allowed to perform file copying through the mobile storage device interface, executing the device management steps; and if the mobile storage device is prohibited to perform file copying through the mobile storage device interface, giving out an alarm.

In this way, binding of the mobile storage device and the mobile storage device interface is implemented, and an unauthorized mobile storage device is prohibited to perform file copying through the interface, thereby further preventing hostile attacks, and effectively avoiding transmission of incidentally infected viruses.

Optionally, the device processing module is also configured to be used for executing at least one of the following operations:

if the mobile storage device is allowed to perform file copying through the mobile storage device interface, giving out a first prompting message, wherein the first prompting message is used for indicating that the mobile storage device is allowed to perform file copying through the mobile storage device interface;

after recovering the file system of the mobile storage device by using the first mirror image file, giving out a second prompting message, wherein the second prompting message is used for indicating the finish of the file copying of the mobile storage device; and

if the process of recovering the file system of the mobile storage device by using the first mirror image file is interrupted, giving out a third prompting message, wherein the third prompting message is used for indicating the interruption of the file copying of the mobile storage device.

In this way, information prompting is intuitively provided to the user of the mobile storage device through the prompting messages.

For the third embodiment, the present invention provides a device management unit, comprising: a mobile storage device interface, configured to be used for connecting a mobile storage device; a memory, configured to be used for storing a device management program; and a processor, configured to be used for calling the device management program, detecting whether the mobile storage device interface is connected with a mobile storage device, and after detecting that the mobile storage device interface is connected with a mobile storage device, executing the following device management steps: damaging a file system on the connected mobile storage device; receiving a file copy instruction, wherein the file copy instruction is used for indicating to copy an object file to the connected mobile storage device; in response to the file copy instruction, generating a first mirror image file of the file system of the mobile storage device, wherein the first mirror image file comprises the object file; and recovering the file system of the connected mobile storage device by using the first mirror image file.

If the file is directly copied to a USB flash disk and then performing virus killing, the goal of virus checking and killing can also be achieved, but the following operations can not be avoided: after the file copying is finished, in the virus killing process, if the mobile storage device is pulled out of the mobile storage device interface, the mobile storage device can be used normally and perform file copying, and if the file carries a virus, virus transmission can be possibly caused. The device management unit recovers the file system of the mobile storage device by using the mirror image file, thereby avoiding the virus transmission caused by the pull-out of the mobile storage device in the virus killing process.

Optionally, the memory is also used for storing an operating system, wherein the device management program operates on the operating system, and the operating system is customized, so that a user of the connected mobile storage device can perform the file copying operation only through a user interface provided by the device management program.

In this way, a possible malicious act of bypassing the device management method provided by the embodiments of the present invention and directly accessing the operating system to perform file copying can be avoided.

Optionally, the device management unit also comprises a display screen, wherein the display screen is configured to be used for displaying at least one of the following states of the mobile storage device interface: the mobile storage device interface is connected with a mobile storage device; the mobile storage device connected to the mobile storage device interface is allowed to perform file copying through the mobile storage device; the mobile storage device connected to the mobile storage device interface is prohibited to perform file copying through the mobile storage device; the file copying of the mobile storage device connected to the mobile storage device interface is finished; the mobile storage device connected to the mobile storage device interface is in use; after the mobile storage device connected to the mobile storage device interface is disconnected from the mobile storage device interface, the mobile storage device is not reconnected to the mobile storage device interface within the preset time.

In this way, the user of the mobile storage device can clearly and easily know the state of the mobile storage device by observing the display screen.

Optionally, the unit is connected with a file server through a secure channel, wherein the file server stores the object file.

For the fourth embodiment, the present invention provides a storage medium, comprising a device management program, wherein when the device management program is called by a processor, executing the method provided by the first embodiment or any possible implementation way of the first embodiment.

As mentioned above, the use of a mobile storage device poses a risk of information security, especially for an operational technology (OT) system. The traditional OT system adopts a closed design, and the network attack is difficult to pose a threat to it. However, with the development of automated manufacturing and process control technologies, the OT system has adopted IT technology extensively and is no longer a closed system. Yet, the current OT system still lacks a complete security protection mechanism and is more susceptible to the external network attack due to its long running time.

On the other hand, the widespread use of the mobile storage device, such as a USB device and the like, in the OT system, such as a digital factory and the like, greatly increases the security risk. For example, a USB device is used for duplicating firmware or software from a file server of an IT network of an enterprise and copying it to one or more workstations on a factory production line. Once the USB device is infected with virus, the virus may be propagated to the workstations through the copy operation and may be further propagated to a critical control device such as a programmable logic controller (PLC), thereby eventually resulting in the breakdown of the entire OT system.

The embodiment of the present invention provides a control method, unit and system of mobile storage devices, which can effectively avoid security threats caused by the use of USB devices and other mobile storage devices when being applied to an OT system. It should be noted that the embodiments of the present invention are not only applicable to the OT system, but also applicable to any system using the mobile storage devices.

In the embodiment of the present invention, after a mobile storage device is inserted into a mobile storage device interface provided by a device management unit, the device management unit damages a file system on the mobile storage device, and generates a mirror image file of the file system of the mobile storage device after receiving a file copy instruction, wherein the first mirror image file comprises an object file which is to be copied to the mobile storage device by the file copy instruction; and then, the device management unit recovers the file system of the mobile storage device by using the mirror image file. If the file is directly copied to a USB flash disk and then performing virus killing, the goal of virus checking and killing can also be achieved, but the following operations can not be avoided: after the file copying is finished, in a virus killing process, if the mobile storage device is pulled out of the mobile storage device interface, the mobile storage device can be used normally and perform file copying, and if the file carries a virus, virus transmission can be possibly caused. In the embodiments of the present invention, the device management unit recovers the file system of the mobile storage device by using the mirror image file, thereby avoiding the virus transmission caused by the pull-out of the mobile storage device in the virus killing process.

Some descriptions involved in the embodiments of the present invention will be explained below. It should be noted that these explanations are for the convenience of understanding the embodiments of the present invention and should not be construed as limiting the protection scope of the present invention.

1. Mobile Storage Device

As opposed to a fixed storage device, the mobile storage device is a device capable of performing file copy and storage between different devices, it may include but not limited to:

A USB device, also known as a mobile flash memory device;

A phase change rewritable optical disk drive (PD) device;

A magneto optical (MO) drive device;

A mobile hard disk;

A floppy drive (FD) device; and

A flash memory device, such as a smart media (SM) card, a compact flash (CF) card, a multi media card, a secure digital (SD) card, a memory stick, a TF card and the like.

2. OT System

As defined by Gartner, Inc., the operational technology (OT) implements detection or control by directly supervising and/or controlling physical devices, processes and events in an enterprise by way of hardware and software. An OT system uses a computer to supervise or change the physical state of a system. An industrial control system is an example that may use the OT system. The ICS is implemented on the basis of the computer and is used for remotely supervising and/or controlling, for example, critical processes and physical functions in a factory. Examples of the OT system include a supervisory control and data acquisition (SCADA) system, a distributed control system (DCS), a computer numerical control (CNC) system (including computerized mechanical tools), and a scientific device (such as a digital oscilloscope).

3. Scenarios in which the OT System is Exposed to a Network Attack Due to the Use of the Mobile Storage Device

Scenario I: when a USB device is connected to a file server under an IT environment of a company, malicious software infects the USB device with a virus, then the USB device is connected to an industrial host of a factory. The industrial host generally needs to continuously run and cannot be restarted, so that security patches cannot be installed in time, thus making the industrial host more susceptible to the virus.

Scenario II: a maintainer or an engineer takes a USB device home, the USB device is used on a personal computer at home and is infected with a virus, and the USB device is brought back and used on a production line of a factory.

An employee violates the rules of a company and deliberately infects a USB device with a virus, and replaces a USB device, which is used on a production line and has the same appearance, with the USB device infected with the virus.

There are so many similar scenarios in which a USB device is infected with a virus due to a hostile attack or accidentally, and these scenarios will not be listed one by one herein. Once the OT system is infected with the virus, the critical production process may be affected, even resulting in the breakdown of the entire OT system.

The embodiments of the present invention are described in detail with reference to the accompanying drawings.

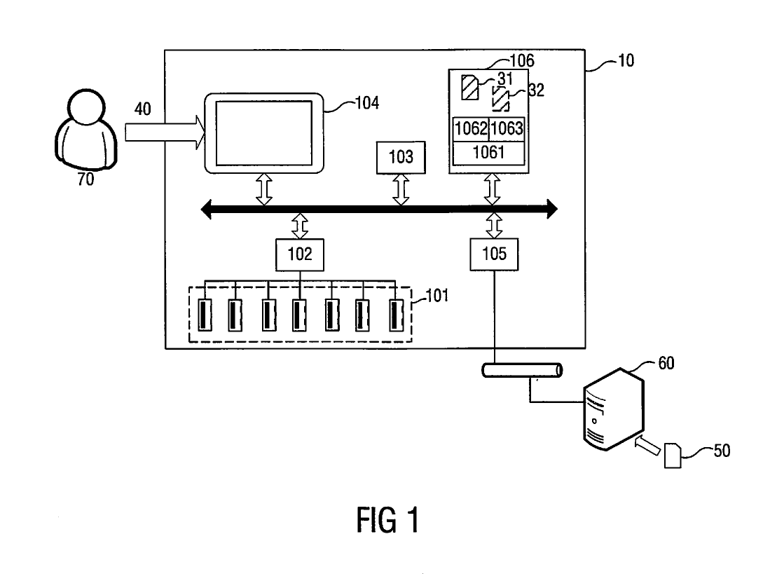

FIG. 1 is a schematic diagram of a device management unit 10 provided by the embodiment of the present invention. As shown in FIG. 1, the unit can comprise:

at least one mobile storage device interface 101, wherein each mobile storage device interface 101 is used for connecting a mobile storage device 20.

Optionally, each mobile storage device interface 101 is connected with a processor 103 of the device management unit 10 through an interface control card 102.

A processor 103, configured to be used for calling a device management program 1062 stored in a memory 106, and executing the device management method provided by the embodiment of the present invention.

The memory 106, in which an operating system 1061 and the device management program 1062 operating on the operating system 1061 are stored. Optionally, the operating system 1061 can be customized, so that a user 70 of the mobile storage device 20 can perform the file copying operation only through a user interface provided by the device management program 1062, thereby avoiding a possible malicious act of bypassing the device management method provided by the embodiments of the present invention and directly accessing the operating system to perform file copying. In addition, a first mirror image file 31 or a second mirror image file 32 of the mobile storage device 20 is also stored in the memory 106.

A display screen 104, which can be used for displaying the user interface. The user 70 of the mobile storage device 20 can send a file copy instruction 40 through the user interface and check the file copying state and the like of the mobile storage device 20. Optionally, the display screen 104 is a touch screen, and the user 70 completes operations on the user interface through the touch screen.

A network interface 105, which can be used for connecting a file server 60, wherein the file server 60 stores an object file 50 to be copied. When the embodiment of the present invention is applied to an OT system, the file server 60 can be a file server in other security domains (such as an office network) which is not connected with the OT system, and thus, can be infected by viruses. Or, in the embodiment of the present invention, the object file 50 can be in another mobile storage device 20 which is connected to another mobile storage device interface 101.

Optionally, the device management unit 10 can also perform authentication on the user 70. Only an authenticated user can perform file copying through the device management unit 10. Many ways for authentication can be used, for example, the user 70 inputs a user name and a password, and the device management unit 10 verifies the user name and the password. Or the device management unit 10 provides a card reader, the user 70 inserts an employee card into the card reader, and the card reader authenticates the user 70. Optionally, a mechanical locking device can be installed to each mobile storage device interface 101. If the user 70 is not authenticated, the locking device locks the mobile storage device 20 connected to the mobile storage device interface 101, and the user can not pull the mobile storage device 20 out of the interface.

The device management unit 10 provided by the embodiment of the present invention can be connected with the file server 60 through a secure channel, for example, a Virtual Private Network (VPN).

In addition, an antivirus program 1063 can also operate in the memory 106, and the processor 103 calls the antivirus program 1063 to perform virus checking and/or virus killing on the object file to be copied. Optionally, the antivirus program 1063 can comprise many different types of antivirus software, and different types of antivirus software are used for performing virus checking and killing on the object file 50 to be copied, thereby avoiding the problem of incomprehensive virus killing of a single type of software.

As shown in FIG. 1, the device management unit 10 provided by the embodiment of the present invention can be implemented by a host, the host is not externally connected with a keyboard or a mouse, the interfaces of the keyboard and mouse can be locked by a physical unit, and the keyboard and/or mouse can be used for performing system maintenance only after being unlocked with a key. Various components in the device management unit 10 can be connected with each other through buses, and the buses include, but not limited to data buses, address buses and control buses. The components can also be connected not through the buses, and the processor 103 is directly connected with the other components.

Optionally, various mobile storage device interfaces 101 can be implemented in an interface array way. The interface array can comprise tens of interfaces with which the mobile storage devices 20 are bound, i.e., only a mobile storage device interface 101 which is bound with one of the interfaces can perform file copying through the interface, and a mobile storage device 20 which is not bound can not perform file copying through the interface. One optional implementation way is that one interface is only bound with one mobile storage device 20, thereby ensuring that one mobile storage device (20) can perform file copying only through the interface bound with the mobile storage device (20). Taking USB flash disks as an example, a USB flash disk has a Universally Unique Identifier (UUID). The device management unit 10 provided by the embodiment of the present invention records the UUID of the USB flash disk bound with each mobile storage device interface 101. When a USB flash disk is inserted into a mobile storage device interface 101, the device management unit 10 reads the UUID of the USB flash disk and performs comparison with the recorded UUID of the USB flash disk bound with the interface, if consistent, determines that the inserted USB flash disk is bound with the interface, and otherwise, determines that the inserted USB flash disk is not bound with the interface. In addition, an identifier can be set in the file system of the mobile storage device 20. The device management unit 10 records the binding relation between the set identifier and a mobile storage device interface 101, and when a mobile storage device 20 is inserted into an interface, inspects the binding relation.

Optionally, the display screen 104 can display the state of each mobile storage device interface 101, and optionally, can give out an alarm under an abnormal condition. For example, when a mobile storage device 20 bound with a mobile storage device interface 101 is inserted into the interface, the processor 103 can control the display screen 104 to display the state of the interface as ‘Device Connected Normally’ by calling the device management program 1062; and when a mobile storage device 20 is inserted into an unbound mobile storage device interface 101, the display screen 104 can be controlled to display the state of the interface as ‘Connection Abnormal’ and give out a sound alarm, so that file copying and other subsequent operations are prohibited. Through binding the mobile storage device 20 with the mobile storage device interface 101, the unbound mobile storage device 20 can be effectively prevented from being inserted into the interface and performing the file copying operation.

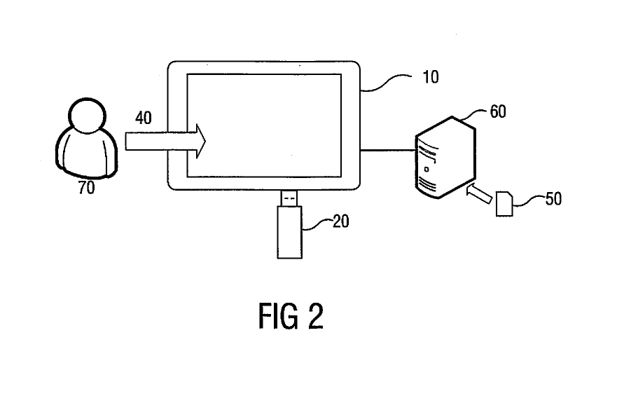

As shown in FIG. 2, the device management unit 10 provided by the embodiment of the present invention can also be implemented by a portable electronic device, such as a tablet computer, notebook computer, smartphone or the like. The portable electronic device is provided with a built-in interface which can be connected with the mobile storage device 20, and optionally, can also be connected with an external file server 60 through a network card and establish a VPN connection with the file server 60, thereby ensuring the communication security. The internal implementation of the portable electronic device as shown in FIG. 2 can also be as shown in FIG. 1. By adopting the implementation way as shown in FIG. 2, the user operations are convenient, and a developer only needs to develop the device management program 1062 and does not need to modify the hardware of the existing device, which is easier to implement.

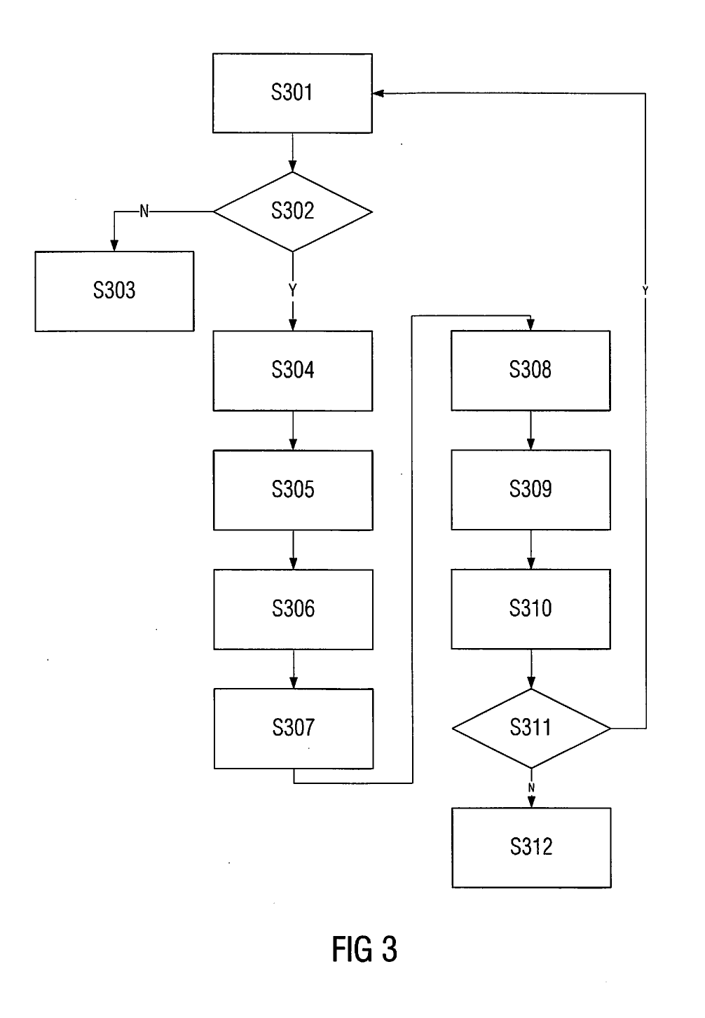

The device management unit 10 provided by the embodiment of the present invention is introduced above. The unit implements management on the storage operation of the mobile storage devices 20 by controlling various mobile storage device interfaces 101. The specific process of managing the mobile storage devices by the unit is described in combination with FIG. 3. As shown in FIG. 3, the process can comprise the following steps:

S301: Detecting that a mobile storage device 20 is inserted into a mobile storage device interface 101 by the device management unit 10. The device management unit 10 can monitor the state of each mobile storage device interface 101 in real time and judge whether a mobile storage device 20 is inserted into an interface or not.

S302: Judging whether the mobile storage device 20 is bound with the interface, i.e., whether the mobile storage device 20 is allowed to perform file copying through the interface or not. If the mobile storage device 20 is bound with the interface, executing step S304, and otherwise, executing step S303.

S303: Displaying the interface state as ‘Connection Abnormal’ on the display screen 104, for example, displaying the color of the interface as ‘Red’, and optionally, can give out a sound alarm and prohibit the file copying operation.

S304: Displaying the interface state as ‘Device Connected Normally’ on the display screen 104, for example, displaying the color of the interface as ‘Green’.

S305: Preprocessing the mobile storage device 20.

The embodiments of the present invention can be implemented by many optional ways when preprocessing is performed on the mobile storage device 20:

Way 1

Acquiring a parameter required by recovering the file system of the mobile storage device 20 (for example, the storage space size of the mobile storage device 20, the format of the file system of the mobile storage device 20, the size and quantity of data blocks or clusters of the file system, and the like), organizing the data blocks into a file and directory structure, and recording which data blocks are allocated to which file, which data blocks are not used, and the like, thereby facilitating the subsequent generation of the first mirror image file 31 of the file system of the mobile storage device 20. One possible situation is: no file is stored in the mobile storage device 20, and at this time, the parameter required by recovering the file system of the mobile storage device 20 also comprises relevant information of the data blocks and the file and directory (possibly only one root directory and corresponding system directory here) structure. The first mirror image file 31 comprises the object file 50 to be copied. Optionally, in the preprocessing process, the mobile storage device 20 can be formatted.

Way 2

Generating a second mirror image file 32 of the file system of the mobile storage device 20, wherein the second mirror image file 32 corresponds to the situation that the storage content in the mobile storage device 20 is null. For example, firstly formatting the mobile storage device 20, and then generating the second mirror image file 32 and storing the second mirror image file 32 into a hard disk 102.

S306: After preprocessing the mobile storage device 20 by the step S305, damaging the file system on the mobile storage device 20. In general, an area corresponding to an initial part of a file system is used for storing the properties of the file system (for example, the size and quantity of data blocks or clusters, and the like), and additionally, can also be used for recording the process of organizing the data blocks into the file and directory structure and also recording which data blocks are allocated to which file, which data blocks are not used, and the like. Therefore, the file system can be damaged by clearing the whole area for locating the initial part of the file system on the mobile storage device 20, or by clearing the whole file system.

Since the damaged file system of the mobile storage device 20 is not available, if the mobile storage device 20 is pulled out of the mobile storage device interface 101 at this time, the mobile storage device 20 is not available. Optionally, the mobile storage device 20 can also give out an alarm, which is configured to be used for prompting an ongoing faulty operation.

S307: Receiving a file copy instruction 40 from a user 70. For example, the user 70 selects an object file 50 to be copied on the touch screen of the portable electronic device as shown in FIG. 2 and determines to copy the object file 50 into the mobile storage device 20.

S308: In response to the file copy instruction 40, generating a first mirror image file 31 of the file system of the mobile storage device 20.

If the Way 1 is adopted to perform preprocessing in the step S305, then in the step S308, the device management unit 10 generates the first mirror image file 31 of the file system of the mobile storage device 20 according to the storage space size of the mobile storage device 20 and the format of the file system of the mobile storage device 20 which are in the step S305, wherein the first mirror image file 31 comprises the object file 50.

If the Way 2 is adopted to perform preprocessing in the step S305, then in the step S308, the device management unit 10 writes the object file 50 into a second mirror image file 32 so as to generate the first mirror image file 31.

S309: Recovering the file system of the mobile storage device 20 by the device management unit 10 by using the first mirror image file 31. Optionally, after successfully recovering the file system of the mobile storage device 20 by using the first mirror image file 31, displaying the interface state as ‘File copied Successfully’ on the display screen 104, for example, displaying the color of the interface as ‘Yellow’, and optionally, giving out a sound prompt to prompt the user 70 to pull the mobile storage device 20 out of the interface. Then, the user 70 can pull the mobile storage device 20 out of the interface. When the embodiment of the present invention is applied to an OT system, the user 70 can copy the copied firmware or software into the OT system so as to be used for industrial production. Optionally, if a process terminal for recovering the file system, the user 70 for instance, pulls the device out of the interface in the process of recovering the file system of the mobile storage device 20, the device management unit 10 can give out an alarm.

Optionally, before generating the first mirror image file 31, the device management unit 10 can inspect whether the object file 50 contains a virus or not; and if the object file 50 does not contain viruses, generate the first mirror image file 31. Or, before recovering the file system of the mobile storage device 20 by using the first mirror image file 31, the device management unit 10 inspects whether the first mirror image file 31 contains a virus or not; if the first mirror image file 31 does not contain viruses, recover the file system of the mobile storage device 20 by using the first mirror image file 31.

S310: After the user 70 pulls out the mobile storage device 20, i.e., the mobile storage device 20 is disconnected from the mobile storage device interface 101, displaying the interface state as Device In Use′ on the display screen 104 by the device management unit 10, for example, displaying the color of the interface as ‘Orange’.

S311: Judging whether the mobile storage device 20 is inserted back into the mobile storage device interface 101 bound with the mobile storage device 20 after being pulled out within the present time (for example, within 12 hours, or before off-work time of the current day) or not, i.e., reconnected to the mobile storage device interface 101 bound with the mobile storage device 20; if so, returning to the step S301, and otherwise, executing step S312.

S312: Giving out an alarm by the device management unit 10.

In the steps above, the device management unit 10 can give out an alarm by making a sound through a connected loudspeaker, and can also give out an alarm by the flickering of a connected indicator lamp, or send the alarm message to a predefined user terminal, for example, a cell phone of a system manager.

Optionally, after detecting that a mobile storage device 20 is inserted into a mobile storage device interface 101 in the step S301, authenticating the user 70. If authenticated, allowing the execution of subsequent operations, and otherwise, prohibiting further operations. Optionally, recording the operations executed by the user 70, thereby bringing convenience to auditing afterwards.

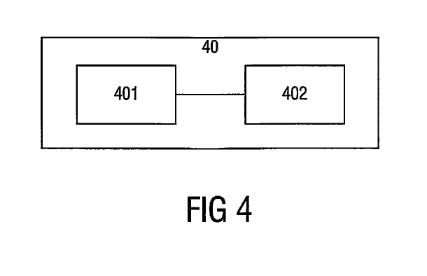

The process of the mobile storage device management method provided by the embodiment of the present invention is described above. FIG. 4 shows a structure diagram of another device management unit 30 provided by the embodiment of the present invention. As shown in FIG. 4, the unit can comprise:

an interface detection module 301, configured to be used for detecting whether a mobile storage device interface 101 of the device management unit 10 is inserted into a mobile storage device 20 or not; and

a device processing module 302, configured to be used for, after the detection module 301 detects that the mobile storage device interface 101 is inserted into a mobile storage device 20, executing the following device management steps: damaging a file system on the mobile storage device 20; receiving a file copy instruction 40, wherein the file copy instruction 40 is used for indicating to copy an object file 50 to the mobile storage device 20; in response to the file copy instruction 40, generating a first mirror image file 31 of the file system of the mobile storage device 20, wherein the first mirror image file 31 comprises the object file 50; and recovering the file system of the mobile storage device 20 by using the first mirror image file 31.

Optionally, the device processing module 302 can also be configured to be used for, before damaging the file system on the mobile storage device 20, acquiring a first parameter, wherein the first parameter comprises the storage space size of the mobile storage device 20 and the format of the file system of the mobile storage device 20; the device processing module 302, when generating the first mirror image file 31, is specifically configured to be suitable for generating the first mirror image file 31 according to the first parameter and the object file 50. Or, the device processing module 302 is also configured to be used for, before damaging the file system on the mobile storage device 20, generating a second mirror image file 32 of the file system of the mobile storage device 20, wherein the second mirror image file 32 corresponds to the situation that the storage content in the mobile storage device 20 is null; the device processing module 302, when generating the first mirror image file 31, is specifically configured to be suitable for writing the object file 50 into the second mirror image file 32 to generate the first mirror image file 31.

Optionally, the device processing module 302 is also configured to be used for, before generating the first mirror image file 31, inspecting whether the object file 50 contains a virus or not; the device processing module 302, when generating the first mirror image file 31, is specifically configured to be suitable for, if the object file 50 does not contain viruses, generating the first mirror image file 31; or the device processing module 302 is also configured to be used for, before recovering the file system of the mobile storage device 20 by using the first mirror image file 31, inspecting whether the first mirror image file 31 contains a virus or not; the device processing module 302, when recovering the file system of the mobile storage device 20 by using the first mirror image file 31, is specifically configured to be suitable for, if the first mirror image file 31 does not contain viruses, recovering the file system of the mobile storage device 20 by using the first mirror image file 31.

Optionally, the device processing module 302 is also used for, before damaging the file system on the mobile storage device 20, formatting the file system of the mobile storage device 20.

Optionally, the device processing module 302 is also configured to be used for, after detecting that a mobile storage device 20 is inserted into a mobile storage device interface 101, before executing the device management steps, judging whether the mobile storage device 20 is allowed to perform file copying through the mobile storage device interface 101; if the mobile storage device 20 is allowed to perform file copying through the mobile storage device interface 101, executing the device management steps; and if the mobile storage device 20 is prohibited to perform file copying through the mobile storage device interface 101, giving out an alarm.

Optionally, the device processing module 302 is also configured to be used for executing at least one of the following operations: if the mobile storage device 20 is allowed to perform file copying through the mobile storage device interface 101, giving out a first prompting message, wherein the first prompting message is used for indicating that the mobile storage device 20 is allowed to perform file copying through the mobile storage device interface 101; and/or after recovering the file system of the mobile storage device 20 by using the first mirror image file 31, giving out a second prompting message, wherein the second prompting message is used for indicating the finish of the file copying of the mobile storage device 20; if the process of recovering the file system of the mobile storage device 20 by using the first mirror image file 31 is interrupted, giving out a third prompting message, wherein the third prompting message is used for indicating the interruption of the file copying of the mobile storage device 20.

For other optional implementation ways of the unit, refer to the process as shown in the reference diagram 3, and no repetition will be made here.

The interface detection module 301 and device processing module 302 contained in the unit 30 as shown in FIG. 4 can also be seen as program modules in the device management program 1062 in FIG. 1, and can be called by the processor 103 in the device management unit 10 to implement the device management function of the device management unit 10 and/or execute the process of the method as shown in FIG. 3.

The embodiment of the present invention also provides a storage medium in which a device management program 1062 can be stored. During operation, the program implements the device management function of the device management unit 10 and/or execute the process of the method as shown in FIG. 3. The storage medium can be a floppy disk, hard disk, internal memory, magneto optical disk, optical disk, magnetic tape and non-volatile storage card. The storage medium can also be storage resources in a remote server (for example, an application server, and the remote server can be set in the cloud); and the device management unit 10 can download the device management program 1062 from the remote server, and operate the device management program 1062 on a local device or operate the device management program 1062 in the form of microservice.

In conclusion, the embodiment of the present invention provides a control method and unit of mobile storage devices, a computer program and a storage medium. After a mobile storage device is inserted into a mobile storage device interface provided by the device management unit, the device management unit damages the file system on the mobile storage device, and generates a mirror image file of the file system of the mobile storage device after receiving a file copy instruction, wherein the first mirror image file comprises an object file which is to be copied to the mobile storage device by the file copy instruction; and then, the device management unit recovers the file system of the mobile storage device by using the mirror image file. If the file is directly copied to a USB flash disk and then performing virus killing, the goal of virus checking and killing can also be achieved, but the following operations cannot be avoided: after the file copying is finished, in the virus killing process, if the mobile storage device is pulled out of the mobile storage device interface, the mobile storage device can be used normally and perform file copying, and if the file carries a virus, virus transmission can be possibly caused. In the embodiment of the present invention, the device management unit recovers the file system of the mobile storage device by using the mirror image file, thereby avoiding the virus transmission caused by the pull-out of the mobile storage device in the virus killing process.

The embodiment of the present invention can be used for performing management on mobile storage devices in an OT system, and can be easily integrated into the production process of the OT system by using various techniques and mechanisms without the need for modifying the existing OT system, industrial devices and industrial production processes. The embodiment of the present invention can be used for copying firmware and/or software used in the OT system from an IT system to effectively lower the security risks of the OT system.

It needs to be noted that not all of the steps and modules in the above processes and system structure diagrams are necessary, and certain steps or modules may be omitted according to actual demands. The execution sequence of the steps is not fixed and may be adjusted according to demands. The system structure described in the above embodiments may be a physical structure or a logical structure, i.e., some modules may be implemented by the same physical entity, or some modules may be implemented individually by a plurality of physical entities or may be implemented together by certain components in a plurality of separate devices.

In the above embodiments, a hardware unit may be implemented in a mechanical form or an electrical form. For example, a hardware unit may include a permanent dedicated circuit or logic (such as a special processor, FPGA or ASIC) to complete a corresponding operation. The hardware unit may also include a programmable logic or circuit (such as a general processor or other programmable processor) and may be temporarily set by software to complete the corresponding operation. The specific implementation ways (mechanical form, or dedicated permanent circuit, or temporarily set circuit) may be determined based on cost and time considerations.

Although the present invention is presented and illustrated in detail with reference to the accompanying drawings and preferred embodiments above, the present invention is not limited to these embodiments that have been disclosed. Based on the plurality of embodiments mentioned above, it may be known by those skilled in the art that code auditing device(s) in the different embodiments may be combined to obtain more embodiments of the present invention, and these embodiments also fall within the protection scope of the present invention.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A device management method comprising, after a device management unit detecting that a mobile storage device is connected to a mobile storage device interface provided by the device management unit:
damaging a file system on the mobile storage device;
receiving a file copy instruction, the file copy instruction being usable for indicating to copy an object file to the mobile storage device;
generating, in response to the file copy instruction, a first mirror image file of the file system of the mobile storage device, the first mirror image file including the object file; and
recovering the file system of the mobile storage device using the first mirror image file.

2. The method of claim 1, further comprising:
acquiring, before the damaging of the file system on the mobile storage device, a first parameter, the first parameter being a parameter required by recovering the file system of the mobile storage device; and wherein the generating of the first mirror image file includes generating the first mirror image file according to the first parameter and the object file.

3. The method of claim 1, further comprising:
generating, before the damaging of the file system on the mobile storage device, a second mirror image file of the file system of the mobile storage device, the second mirror image file corresponding to a situation where a storage content in the mobile storage device is null; and wherein the generating of the first mirror image file includes writing the object file into the second mirror image file to generate the first mirror image file.

4. The method of claim 1, further comprising either:
inspecting, before the generating of the first mirror image file, whether the object file contains a virus or not; and wherein the generating of the first mirror image file includes generating, upon the inspecting indicating that the object file does not contain viruses, the first mirror image file; or
inspecting, before the recovering of the file system of the mobile storage device using the first mirror image file, whether the first mirror image file contains a virus or not; and wherein the recovering of the file system of the mobile storage device using the first mirror image file includes recovering, upon the inspecting indicating that the first mirror image file does not contain viruses, the file system of the mobile storage device using the first mirror image file.

5. The method of claim 1, further comprising:
formatting, before the damaging of the file system on the mobile storage device, the file system of the mobile storage device.

6. The method of claim 1, further comprising,
judging, after the detecting that the mobile storage device is connected to the mobile storage device interface and before the damaging of the file system on the mobile storage device, whether or not the mobile storage device is allowed to perform file copying through the mobile storage device interface; wherein, upon the judging indicating that the mobile storage device is allowed to perform file copying through the mobile storage device interface, executing the damaging of the file system on the mobile storage device; and wherein upon the judging indicating that the mobile storage device is prohibited to perform file copying through the mobile storage device interface, executing an alarm.

7. The method of claim 6, further comprising at least one of:
giving out, upon the judging indicating that the mobile storage device is allowed to perform file copying through the mobile storage device interface, a first prompting message, wherein the first prompting message is used for indicating that the mobile storage device is allowed to perform file copying through the mobile storage device interface;
giving out, after the recovering of the file system of the mobile storage device using the first mirror image file, a second prompting message, wherein the second prompting message is used for indicating a finish of the file copying of the mobile storage device; and
giving out, upon the recovering of the file system of the mobile storage device using the first mirror image file being interrupted, a third prompting message, wherein the third prompting message is used for indicating interruption of the file copying of the mobile storage device.

8. A device management unit, comprising:
a mobile storage device interface, configured to connect a mobile storage device;
a memory, configured to store a device management program; and
a processor, configured to call the device management program, for detecting whether the mobile storage device interface is connected with a mobile storage device or not, and after detecting that the mobile storage device interface is connected to a mobile storage device, for executing:
damaging a file system on the mobile storage device;
receiving a file copy instruction, the file copy instruction being usable for indicating to copy an object file to the mobile storage device;
generating, in response to the file copy instruction, a first mirror image file of the file system of the mobile storage device, the first mirror image file including the object file; and
recovering the file system of the mobile storage device using the first mirror image file.

9. The device management unit of claim 8, wherein the memory is further configured to store an operating system, and wherein the device management program is configured to operate on the operating system, and the operating system is customizable to permit a user of the mobile storage device, when connected, to perform file copying only through a user interface provided by the device management program.

10. The device management unit of claim 8, further comprising:
a display screen, configured to display at least one of a plurality of states of the mobile storage device interface including:
the mobile storage device interface being connected with a mobile storage device;
the mobile storage device, connected to the mobile storage device interface, being allowed to perform file copying through the mobile storage device;
the mobile storage device, connected to the mobile storage device interface, being prohibited to perform file copying through the mobile storage device;
the file copying of the mobile storage device, connected to the mobile storage device interface, being completed;
the mobile storage device, connected to the mobile storage device interface, being in use; and
after the mobile storage device, connected to the mobile storage device interface, is disconnected from the mobile storage device interface, the mobile storage device is not reconnected to the mobile storage device interface within a time period.

11. The device management unit of claim 8, wherein the device management unit is connected with a file server through a secure channel, wherein the file server is configured to store the object file.

12. A non-transitory storage medium, storing a device management program for, when execute by a processor, carrying out at least:
damaging a file system on a mobile storage device;
receiving a file copy instruction, the file copy instruction being usable for indicating to copy an object file to the mobile storage device;
generating, in response to the file copy instruction, a first mirror image file of the file system of the mobile storage device, the first mirror image file including the object file; and
recovering the file system of the mobile storage device using the first mirror image file.

13. The non-transitory storage medium of claim 12, wherein
upon the device management program being called by the processor, and before damaging the file system on the mobile storage device, the device management program, when executed by the processor, further executing acquiring a first parameter, the first parameter being the parameter required by recovering the file system of the mobile storage device; and
upon the device management program being called by the processor to generate the first mirror image file, the device management program, when executed by the processor, executing the generating of the first mirror image file according to the first parameter and the object file.

14. The non-transitory storage medium of claim 12, wherein
upon the device management program being called by the processor, and before damaging the file system on the mobile storage device, the device management program, when executed by the processor, further executing generating of a second mirror image file of the file system of the mobile storage device, the second mirror image file corresponding to a situation where storage content in the mobile storage device is null; and
upon the device management program being called by the processor to generate the first mirror image file, the device management program, when executed by the processor, further executing writing the object file into the second mirror image file to generate the first mirror image file.

15. The non-transitory storage medium of claim 12, wherein
upon the device management program being called by the processor, and before the generating of the first mirror image file, the device management program, when executed by the processor, further executing inspecting whether the object file contains a virus or not; and upon the device management program being called by the processor to generate the first mirror image file, the device management program, when executed by the processor, further executing generating of the first mirror image file upon the inspecting indicating that the object file does not contain viruses; or
upon the device management program being called by the processor, and before the recovering of the file system of the mobile storage device using the first mirror image file, the device management program, when executed by the processor, further executing inspecting whether the first mirror image file contains a virus or not; and upon the device management program being called by the processor to recover the file system of the mobile storage device using the first mirror image file, the device management program, when executed by the processor, further executing recovering the file system of the mobile storage device using the first mirror image file, upon the inspecting indicating that the first mirror image file does not contain viruses.

16. The non-transitory storage medium of claim 12, wherein upon the device management program being called by the processor, and before the damaging of the file system on the mobile storage device, the device management program, when executed by the processor, further executing formatting of the file system of the mobile storage device.

17. The non-transitory storage medium of claim 12, wherein upon the device management program being called by the processor, and after detecting that the mobile storage device is connected to a mobile storage device interface and before executing the damaging of the file system on the mobile storage device, the device management program, when executed by the processor, further executing judging whether the mobile storage is allowed to perform file copying through the mobile storage device interface; and
wherein, upon the judging indicating that the mobile storage device is allowed to perform file copying through the mobile storage device interface, the device management program, when executed by the processor, executing the damaging of the file system on the mobile storage device; and wherein upon the judging indicating that the mobile storage device is prohibited to perform file copying through the mobile storage device interface, the device management program, when executed by the processor, executing an alarm.

18. The non-transitory storage medium of claim 17, wherein upon the device management program being called by the processor, the device management program, when executed by the processor, further executing at least one of:
giving out, upon the judging indicating that the mobile storage device is allowed to perform file copying through a mobile storage device interface, a first prompting message, wherein the first prompting message is used for indicating that the mobile storage device is allowed to perform file copying through the mobile storage device interface;
giving out, after the recovering of the file system of the mobile storage device using the first mirror image file, a second prompting message, wherein the second prompting message is used for indicating a finish of the file copying of the mobile storage device; and
giving out, upon the recovering of the file system of the mobile storage device using the first mirror image file being interrupted, a third prompting message, wherein the third prompting message is used for indicating interruption of the file copying of the mobile storage device.

19. The non-transitory storage medium of claim 13, wherein
upon the device management program being called by the processor, and before the generating of the first mirror image file, the device management program, when executed by the processor, further executing inspecting whether the object file contains a virus or not; and upon the device management program being called by the processor to generate the first mirror image file, the device management program, when executed by the processor, further executing generating of the first mirror image file upon the inspecting indicating that the object file does not contain viruses; or
upon the device management program being called by the processor, and before the recovering of the file system of the mobile storage device using the first mirror image file, the device management program, when executed by the processor, further executing inspecting whether the first mirror image file contains a virus or not; and upon the device management program being called by the processor to recover the file system of the mobile storage device using the first mirror image file, the device management program, when executed by the processor, further executing recovering the file system of the mobile storage device using the first mirror image file, upon the inspecting indicating that the first mirror image file does not contain viruses.

20. The method of claim 2, further comprising either:
inspecting, before the generating of the first mirror image file, whether the object file contains a virus or not; and wherein the generating of the first mirror image file includes generating, upon the inspecting indicating that the object file does not contain viruses, the first mirror image file; or
inspecting, before the recovering of the file system of the mobile storage device using the first mirror image file, whether the first mirror image file contains a virus or not; and wherein the recovering of the file system of the mobile storage device using the first mirror image file includes recovering, upon the inspecting indicating that the first mirror image file does not contain viruses, the file system of the mobile storage device using the first mirror image file.
